(19) United States
(12) Patent Application Publication
(10) Pub. No.: US 2026/0245300 A1
(43) Pub. Date: Aug. 20, 2026

(54) 3D PART SEGMENTATION USING PART FIELDS

(71) Applicant: NVIDIA Corporation, Santa Clara, CA (US)

(72) Inventors: Minghua LIU, Santa Clara, CA (US); Tianchang SHEN, Toronto (CA); Mikaela Angelina UY, Santa Clara, CA (US); Nicholas Mark Worth SHARP, Seattle, WA (US); Jun GAO, Toronto (CA); Sanja FIDLER, Toronto (CA)

(73) Assignee: NVIDIA Corporation, Santa Clara, CA (US)

(21) Appl. No.: 19/056,392

(22) Filed: Feb. 18, 2025

(51) Int. Cl. G06T 17/00; G06V 10/762

(52) U.S. Cl. CPC G06T 17/00; G06V 10/762

(57) ABSTRACT

In various examples, a system can include one or more processors to segment, using at least one machine learning model, a first representation of an object into a plurality of parts according to a hierarchy, where the hierarchy indicates groups of datapoints for at least one part of the plurality of parts based on a value. The one or more processors generate at least one second representation of the object based on the at least one of the part of the plurality of parts.

### BACKGROUND

Three-dimensional (3D) part segmentation is used for a variety of purposes such as to recognize and classify objects, generate detailed 3D models, or interpret 3D data, among others. Conventional techniques to segment 3D parts are often limited to specific object categories, such as a chair or a table, and are unable to capture internal structures of the 3D part.

### SUMMARY

Implementations of the present disclosure relate to 3D part segmentation using part fields. Systems and methods are disclosed that convert input geometry into a 3D part feature field via at least one neural network, and applies a clustering algorithm to extract part structures based on the 3D part feature field. The neural network is trained on an extensive 3D dataset without manually annotated 3D part labels. As such, the extracted part structures are not limited to semantic labels, and can be flexibly extracted with varying quantities and granularities via the clustering algorithm.

In contrast to conventional systems, such as those described above, the systems of the present disclosure can include a system that includes one or more processors to segment, using at least one machine learning model, a first representation an object into a plurality of parts according to a hierarchy, where the hierarchy indicates groups of datapoints for at least one part of the plurality of parts based on a value. The one or more processors generate at least one second representation of the object based on at least one part of the plurality of parts.

In various implementations, the value is a granularity value and indicates a number of parts for which to segment the first representation of the object into. At least one of the first representation of the object or the at least one second representation of the object can be a three dimensional (3D) representation. The hierarchy can indicate at least one of a similarity or a distance between datapoints, and the at least one machine learning model clusters the datapoints based on the value using the at least one of the similarity or the distance between the datapoints. To segment the first representation object into the plurality of parts, the one or more processors can generate a feature space including a plurality of feature vectors of first representation of the object. The first representation of the object can be segmented based at least partially on a similarity and a distance between at least two feature vectors of the plurality of feature vectors. The one or more processors can adjust the at least one second representation of the object according to the at least one of the plurality of parts. The one or more processors can generate, using the at least one machine learning model, the first representation of the object prior to segmenting the first representation of the object into the plurality of parts. The at least one second representation of the object can include at least one representation of one of the plurality of parts. The at least one second representation of the object can include at least one of a 3D or four-dimensional (4D) representation. The groups of datapoints can be clusters. The at least one machine learning model can include at least one of: a 3D convolutional U-net, a point-voxel convolutional neural network (PVCNN), a sparse convolutional model, a 3D convolutional neural network, a point cloud model, at least one two-dimensional (2D) convoluter, at least one transformer, or a clustering algorithm.

In various implementations, the one or more processors can be included in at least one of a control system for an autonomous or semi-autonomous machine, a perception system for an autonomous or semi-autonomous machine, a system implemented using a robot, an aerial system, a medical system, a boating system, a smart area monitoring system, a system for performing deep learning operations, a system for performing simulation operations, a system for generating or presenting virtual reality (VR) content, augmented reality (AR) content, or mixed reality (MR) content, a system for performing digital twin operations, a system implemented using an edge device, a system incorporating one or more virtual machines (VMs), a system for generating synthetic data, a system implemented at least partially in a data center, a system for performing conversational artificial intelligence (AI) operations, a system for performing generative AI operations, a system implementing language models, a system implementing vision language models (VLMs), a system implementing large language models (LLMs), a system implementing multi-modal language models, a system for hosting one or more real-time streaming applications, a system for performing light transport simulation, a system using or deploying one or more inference microservices, a system that incorporates one or more machine learning models deployed in a service or microservice along with an OS-level virtualization package (e.g., a container), a system for performing collaborative content creation for 3D assets, or a system implemented at least partially using cloud computing resources.

The systems of the present disclosure can include a system including one or more processors to generate, using a first machine learning model, a first representation of a three dimensional (3D) object including a plurality of feature vectors corresponding to each point of the 3D object. The one or more processors group, using a second machine learning model, the plurality of feature vectors according to a hierarchy based at least in part on a similarity of the plurality of feature vectors. The one or more processors segment the first representation of the 3D object into a plurality of parts based on the groups of feature vectors and generate at least one second representation of the 3D object using at least one of the plurality of parts.

In various implementations, the hierarchy is based on at least one of the similarity or a distance between at least two of the plurality of feature vectors. The plurality of feature vectors can be grouped according to a granularity value of the hierarchy indicative of a threshold for which to cluster the plurality of feature vectors. The second machine learning model can be a clustering algorithm and the plurality of feature vectors are clustered. The at least one second representation of the 3D object can include at least one of a 3D or four-dimensional (4D) representation.

The systems of the present disclosure can include one or more processors to segment, using at least one algorithm, a first representation of a three dimensional (3D) object comprising a plurality of datapoints into a plurality of parts according to a hierarchy, the hierarchy indicative of at least one of a similarity or a distance between each of the plurality of datapoints and generate a second representation of the 3D object using at least one of the plurality of parts.

In various implementations, the first representation of the 3D object is segmented according to a value indicative of a number of parts to segment the first representation of the 3D object into. The at least one algorithm can be a clustering algorithm and the plurality of datapoints can be clustered according to the hierarchy.

### BRIEF DESCRIPTION OF THE DRAWINGS

The present systems and methods for 3D part segmentation using part fields are described in detail below with reference to the attached drawing figures, wherein:

FIG. 1 is a block diagram of an example of a system for segmenting a 3D part, in accordance with some implementations of the present disclosure;

FIG. 2 is a block diagram of an example of a system for training a 3D part feature field model, in accordance with some implementations of the present disclosure;

FIG. 3 is a perspective view of an example part feature field, in accordance with some implementations of the present disclosure;

FIG. 4 is a perspective view of an example part feature field, in accordance with some implementations of the present disclosure;

FIG. 5 is a perspective view of an example of a segmented 3D part, in accordance with some implementations of the present disclosure;

FIG. 6 is a perspective view of another example of a segmented 3D part, in accordance with some implementations of the present disclosure;

FIG. 7 is a perspective view of an example of a segmented 3D part, in accordance with some implementations of the present disclosure;

FIG. 8 is a perspective view of another example of a segmented 3D part, in accordance with some implementations of the present disclosure;

FIG. 9A is a block diagram of an example method for segmenting a 3D part, in accordance with some implementations of the present disclosure;

FIG. 9B is a block diagram of an example method for segmenting an object and generating a representation of the object, in accordance with some implementations of the present disclosure;

FIG. 9C is a block diagram of an example method for segmenting a 3D object and generating a representation of the 3D object, in accordance with some implementations of the present disclosure;

FIG. 9D is a block diagram of an example method for segmenting a 3D object and generating a representation of the 3D object, in accordance with some implementations of the present disclosure;

FIG. 10 is a block diagram of an example computing device suitable for use in implementing some implementations of the present disclosure; and

FIG. 11 is a block diagram of an example data center suitable for use in implementing some implementations of the present disclosure.

### DETAILED DESCRIPTION

Systems and methods are disclosed related to 3D part segmentation using part fields. As non-limiting examples, the neural network can be trained on a variety of 3D parts including both 3D and 2D labels to generate 3D part feature fields given an input 3D geometry. Parts may then be extracted from the 3D part feature fields using a clustering algorithm, such as a hierarchical clustering algorithm. For example, parts of the input 3D geometry may be differentiated based on a distance between vectors of the 3D part feature fields.

This disclosure relates to systems and methods for using generalizable part fields on 3D geometries to extract part structures, such as to enable 3D part segmentation. Conventional methods have attempted to achieve 3D part segmentation, but are limited in their capabilities due to supervised training on a segmentation network, and are typically limited to object categories (e.g., chairs and tables) due to performing per-shape optimization of the models. Other methods may suffer from lengthy inference times, poor quality and 3D consistency, and an inability to capture internal structures of the 3D parts due to a projection of an input 3D geometry onto 2D. Furthermore, conventional segmentation methods focus on semantic, accurate part output while users, such as artists, may desire featurization of geometric parts that are not pre-defined by part templates.

Systems and methods in accordance with the present disclosure can train a feed-forward neural network (e.g., 3D-native network) to directly convert input 3D geometry (e.g., AI-generated 3D parts, CAD models, 3D data, etc.) into a 3D part feature field by applying a clustering algorithm to extract part structures during inference. The output 3D part feature field may be a continuous 3D field that models both a surface and internal structures (e.g., volume) of the 3D geometry. Existing segmentation methods may enable featurization (e.g., labeling) of visible regions and fail to preserve all fine-grained geometric detail. The neural network may be trained on 3D native priors (e.g., training dataset including 3D data, output of 2D foundation models, heuristics, 3D labels, and 2D labels for 3D datasets using 2D models). The neural network may be trained on a comprehensive dataset of 3D native priors making the neural network less susceptible to noise (e.g., variations in data). Training on the comprehensive dataset of 3D native priors may also enable the neural network to receive input 3D geometry for arbitrary object categories (e.g., not limited to semantic object labels) and output 3D part feature fields. For example, instead of being limited to predefined semantic categories or templates (e.g., ball, table), the neural network may receive any 3D part and output a 3D part feature field for the 3D part. A post-processing algorithm (e.g., clustering) may them be applied to the 3D part feature field to extract parts (e.g., hierarchical parts) of the 3D part.

Triplets (e.g., anchor, positive, and negative datapoints) may be constructed to build contrastive losses for supervised training of the neural network. To enable the neural network to be generalizable (e.g., open world) to any part, the neural network may generate pseudo-labels for each 3D part so as to not be limited by semantic labels. Additionally, the post-processing algorithm applied to the 3D part feature field generated by the neural network may extract parts with varying quantities and granularities. The post-processing algorithm may be at least one of a hierarchical K-means clustering or agglomerative clustering algorithm. The quantities and granularities used by the post-processing algorithm may be adjusted via training and/or by the user.

The systems and methods in accordance with the present disclosure may be applied to various technical fields, such as 3D shape generation, simulation, autonomous driving, animation, and editing AI-generated meshes. For example, systems and methods in accordance with the present disclosure enable generation of meshes per part instead of an entire object. In some implementations, the systems and methods described herein may provide segmentation data to a simulation environment (e.g., NVIDIA's DriveSIM) for the simulation environment to identify regions of interest (e.g., legs, arms) to perform operations associated with the segments of the 3D part. The simulation environment may be built into applications or software platforms for creating, generating, modifying, or manipulating 3D models or parts. In some embodiments, the simulation environment and/or one or more objects, features, or components thereof may be generated or managed within a three-dimensional (3D) content collaboration platform (e.g., NVIDIA's OMNIVERSE, NVIDIA's Edify 3D, NVIDIA's Holodeck) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), creating, generating and/or other tasks related to automotive, robot, machine, architecture, gaming, art, animation, anatomy, or other applications.

The systems and methods described herein may be used for a variety of purposes, by way of example and without limitation and at least partially described above and further herein, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications. For example, the systems and methods described herein may receive a synthetically generated 3D geometry, and output segmentation of the 3D geometry into parts, as well as an internal structure of the 3D geometry. The parts may then be manipulated, used, generated, tested, and/or other tasks related to augmented reality, virtual reality, mixed reality, collaborative content creations for 3D assets, among others. For example, the parts may be used by a collaborative content creation platform to animate the 3D geometry.

Disclosed implementations may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for performing generative AI operations, systems for implementing language models, systems for implementing vision language models (VLMs), systems for implementing large language models (LLMs), systems for implementing multi-modal language models, systems for hosting one or more real-time streaming applications, systems for generating or presenting virtual reality (VR) content, augmented reality (AR) content, or mixed reality (MR) content, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

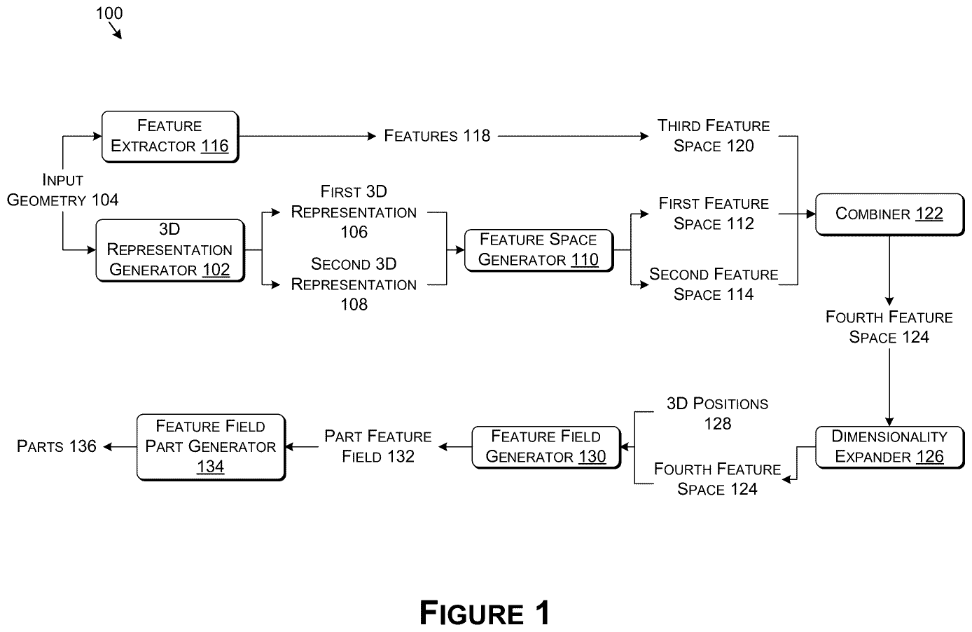

With reference to FIG. 1, FIG. 1 is an example system for segmenting a 3D part, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 can include one or more 3D representation generators 102. The 3D representation generators 102 can receive input geometry 104 (e.g., first representation), and generate a 3D representation of the input geometry 104. The input geometry 104 can be a 3D geometry of a 3D volume, and can include, but not limited to a computer aided design (CAD) model or 3D geometry generated by a generative artificial intelligence (AI) model. The 3D volume can be any volume, such as, but not limited to, a couch, a chair, or a car, in a 3D form. For example, the input geometry 104 can be a CAD model of a car. The 3D volume can be generated by a machine learning model, such as a generative artificial intelligence (AI) model.

Once the 3D representation generator 102 receives the input geometry 104, the 3D representation generator 102 can generate at least one 3D representation. The 3D representation can model and represent the geometry of the 3D volume. The 3D representation can have different formats such as, but not limited to, a signed distance function (SDF) volume (e.g., encoded distance for each point of the input geometry 104), a point cloud (e.g., collection of spatial coordinates of the input geometry 104), a mesh representation (e.g., including vertices, edges, faces), a volumetric pixel (e.g., voxel) grid, or a parameter point model. For example, the 3D representation generator 102 can generate a first 3D representation 106 and a second 3D representation 108. In this case, the first 3D representation 106 can be a point cloud while the second 3D representation 108 is an SDF volume. The point cloud can have, for example, 100,000 points on three dimensions and the SDF volume can have a resolution of 256 pixels cubed. In some implementations, the 3D representation generator 102 only generates the first 3D representation 106 off of the input geometry 104. In some implementations, the 3D representation generator 102 generates two or more 3D representations. In this case, the two or more 3D representations may each have different formats. For example, a first 3D representation is an SDF volume, a second 3D representation is a point cloud, and a third 3D representation is a mesh representation.

The system 100 can include one or more feature space generators 110. Following generation of, for example, the first 3D representation 106 and the second 3D representation 108, the feature space generator 110 can encode the first 3D representation 106 and the second 3D representation 108. The feature space generator 110 can receive and encode the first 3D representation 106 and the second 3D representation 108 using a plurality of first neural networks. The plurality of first neural networks can include at least one of a 3D convolutional U-net, a point-voxel convolutional neural network (PVCNN), a sparse convolutional model, a 3D convolutional neural network, or a point cloud model. The feature space generator 110 encodes the first 3D representation 106 and the second 3D representation 108 into a first feature space 112 and a second feature space 114, respectively. In some implementations, the feature space generator 110 generates only the first feature space 112, responsive to the 3D representation generator 102 only generating the first 3D representation 106. The feature space generator 110 generates a feature space for each of the 3D representations received by encoding the 3D representations via the plurality of first neural networks.

The feature space can be a triplane. The triplane can include three two-dimensional grids (e.g., XY, YZ, and XZ axes of a 3D space) with each plane storing feature maps (e.g., appearance, geometry information). The plurality of first neural networks encode the feature maps from the 3D representations. The feature maps can include a plurality of feature vectors (e.g., mathematical representation of characteristics of the 3D volume). Each of the feature spaces generated by the feature space generator 110 can include the plurality of feature vectors. The feature space generator 110 can encode each 3D representation received and generate one dimensional feature vectors at each point of the 3D representation. For example, the first feature space 112 can include a plurality of first feature vectors and the second feature space 114 can include a plurality of second feature vectors. Each of the plurality of first feature vectors and the plurality of second vectors are located at different points on the input geometry 104 and may represent different information, such as distance.

As an example, responsive to receiving the first 3D representation 106 in a SDF volume format and the second 3D representation 108 in a point cloud format, the feature space generator 110 generates the first feature space 112 as an SDF feature space (e.g., SDF triplane) and the second feature space 114 as a point cloud feature space (e.g., point cloud triplane). The first feature space 112 can have a resolution of, for example, 128 pixels cubed on three dimensions (e.g., planes). The second feature space 114 can also have a resolution of, for example, 128 pixels cubed on three dimensions.

In some implementations, the system includes one or more feature extractors 116. The feature extractor 116 can receive the input geometry 104 and determine (e.g., extract) features 118 (e.g., foundation features). The feature extractor 116 may receive the input geometry 104 before, after, or simultaneously with the 3D representation generator 102. The feature extractor 116 can determine the features 118 by determining surface features of the 3D volume via the input geometry 104. The surface features can include at least one of color, texture, or other surface attributes. The feature extractor 116 can extract, for example, a color histogram, color moments, local binary patterns, fractal dimension, or wavelets from the input geometry 104. The feature extractor 116 can also render the input geometry 104 into a 3D image and input the 2D image into a plurality of self-supervised learning models to encode the 3D image and generate features of the input geometry 104. The plurality of self-supervised learning models can include, but not limited to, a self-distillation with no labels (DINO) model, a segment anything model (SAM), or foundation models. The plurality of self-supervised learning models can encode the input geometry 104 to extract additional features 118 of the input geometry 104 such as surface attributes.

Based on the features 118, the feature extractor 116 can generate a feature space (e.g., a third feature space 120). The third feature space 120 can include a plurality of third feature vectors. For example, the feature extractor 116 can combine the features 118 at each point on the input geometry 104 into a plurality of third feature vectors. As another example, provided a 2D image and/or a 2D input geometry, the feature extractor 116 can encode the 2D image into 3D geometry, and generate the third feature space 120 based on the 3D geometry. In some implementations, to extract the features 118, the feature extractor 116 can receive the input geometry 104 and render the input geometry 104 into a 2D image. The feature extractor 116 can then extract the features 118, such as color, from the rendered 2D image of the input geometry 104. Following extraction of the features 118, the feature extractor 116 can generate the third feature space 120 off the rendered 2D image.

The system 100 can include one or more combiners 122. The combiner 122 can combine (e.g., concatenate) at least the first feature space 112 and the second feature space 114 into a fourth feature space 124. For example, the combiner 122 can combine the plurality of first feature vectors and the plurality of second feature vectors into the fourth feature space 124 including a plurality of fourth feature vectors. For example, the combiner 122 can concatenate a point cloud triplane (e.g., the first feature space 112) and an SDF triplane (e.g., the second feature space 114) into a triplane (e.g., the fourth feature space 124) with a higher resolution than the point cloud triplane or the SDF triplane. The fourth feature space 124 thus contains more data (e.g., information) than either the first feature space 112 or the second feature space 114. The combiner 122 combines the feature vectors at each point on the first feature space 112 and the second feature space 114 to generate the fourth feature space 124. The combiner 122 can include at least one machine learning model, such as a convolutional neural network (CNN) to combine the feature vectors of the first feature space 112 and the second feature space 114.

In some implementations, the combiner 122 receives the first feature space 112, the second feature space 114, and the third feature space 120. As a result, the combiner 122 combines the plurality of first feature vectors, the plurality of second feature vectors, and the plurality of third feature vectors to generate the fourth feature space 124. In this case, a channel dimension (e.g., number of layers, feature maps, and/or signal channels) of the fourth feature space 124 may be higher than the channel dimension of the fourth feature space 124 without a combination of the third feature vector. The plurality of fourth feature vectors, in this case, can represent surface attributes, distance, or coordinates (e.g., from the point cloud), among others.

The system 100 can include one or more dimensionality expanders 126. The dimensionality expander 126 can receive the fourth feature space 124, and increase a dimension of the plurality of fourth feature vectors. For example, the dimensionality expander 126 can increase a channel dimension of the fourth feature space 124. To do so, the dimensionality expander 126 can include a plurality of second neural networks. The plurality of second neural networks can include at least one 2D convoluter and at least one transformer. In some implementations, the plurality of second neural networks includes at least 6 layers of transformers. The transformers can have a dimension of 1024. The at least one 2D convoluters (e.g., convolutional blocks) and at least one transformers can be applied to the fourth feature space 124 sequentially. As a result of the dimensionality expander 126 applying the fourth feature space 124 to the plurality of neural networks, a channel dimension (e.g., dimension of the plurality of fourth feature vectors) can increase from, for example, 128 to 512. For example, the dimensionality expander 126 can apply linear projections to the fourth feature space 124 to increase the channel dimension. The fourth feature space 124 can have a same spatial resolution as the first feature space 112 and the second feature space 114 such as a spatial resolution of 128×128. Following application to the plurality of second neural networks, the fourth feature space 124 may be converted to 2D.

In some implementations, the feature space generator 110 and/or the feature extractor 116 only generates one feature space (e.g., the first feature space 112). In this case, the first feature space 112 is provided to the dimensionality expander 126, and the dimensionality expander 126 increases the dimension of the first feature space 112.

Following an increase in the dimension of the fourth feature space 124 by the dimensionality expander 126, the fourth feature space 124 is provided to a feature field generator 130 along with 3D positions 128 (e.g., locations of a plurality of 3D points) of the 3D volume. The feature field generator 130 can include at least one neural network. The 3D positions 128 can be 3D locations of points on a surface of the 3D volume, and can be determined from the input geometry 104. For example, the 3D representation generator 102 can extract the 3D positions 128 from vertex data stored in the input geometry 104. As another example, the feature space generator 110 can determine the 3D positions 128 from a point cloud generated by the 3D representation generator 102.

Taking the 3D positions 128 and the fourth feature space 124, the feature field generator 130 can project the 3D positions 128 onto the fourth feature space 124 to combine the plurality of fourth feature vectors with the 3D positions 128. For example, the feature field generator 130 projects the 3D positions 128 onto the 2D image (e.g., the fourth feature space 124). As a result, each pixel of the 2D image also has a corresponding 3D location (e.g., 3D position 128). The feature field generator 130 may project the 3D positions 128 onto the fourth feature space 124 at one view (e.g., angle) at a time. For example, the feature field generator 130 only projects the 3D positions 128 onto the fourth feature space 124 at one view. With the three planes (e.g., triplane) of the fourth feature space 124, the feature field generator 130 can sum the projections of the 3D positions 128 over the three feature planes.

Following projection, the feature field generator 130 can split the fourth feature space 124 by its channel dimension (e.g., number of layers). For example, the feature field generator 130 can split the fourth feature space 124 into a first portion (e.g., a portion of the combination of the plurality of third feature vectors and the 3D positions 128) and a second portion. The first portion can have, for example, a dimension of 448 (e.g., 448 layers or feature maps) to generate a part feature field 132. The second portion can have a dimension of 64. In some implementations, the second portion is used to update (e.g., train) the feature field generator 130. For deployment, the second portion may not be used while the first portion is used to generate the part feature field 132. The part feature field 132 can include a plurality of part feature vectors. The feature field generator 130 can generate vectors and place vectors on the part feature field 132 based on its plurality of weights as well as the 3D positions 128 and the fourth feature space 124. The feature field generator 130 can combine the 3D positions 128 and the plurality of fourth feature vectors to generate the part feature field 132. The part feature field 132 may include a fourth feature vector at each of the 3D positions 128 summed over each plane of the triplane (e.g., the fourth feature space 124). The feature field generator 130 can determine a distance between the plurality of part feature vectors (e.g., by placing the part feature vectors) which can dictate part segmentation.

Once the feature field generator 130 generates the part feature field 132, the part feature field 132 can be provided to a feature field part generator 134. The feature field part generator 134 can include one or more clustering algorithms to segment the part feature field 132 into at least one part 136. The parts 136 may be parts (e.g., segments) of the 3D volume as represented by the input geometry 104. The clustering algorithms can include, for example but not limited to, hierarchical K-means clustering, agglomerative clustering, density-based clustering, grid-based clustering, model-based clustering, fuzzy clustering, spectral clustering, or graph-based clustering. The clustering algorithm can segment the part feature field 132 according to a hierarchy. The hierarchy can indicate at least one of a similarity or distance between each of the plurality of feature vectors. For example, the clustering algorithm may segment the part feature field 132 into parts 136 based at least in part on a distance (e.g., similarity) between the plurality of part feature vectors (e.g., datapoints). For example, the clustering algorithm may include a threshold. The threshold may be indicative of a maximum distance between two of the plurality of part feature vectors to be clustered as a same part of the parts 136. Responsive to the distance exceeding the threshold, the clustering algorithm determines that the two part feature vectors are a part of different parts 136. Responsive to the distance between a portion the plurality of part feature vectors being at or below a threshold, the portion of the plurality of part feature vectors are clustered by the clustering algorithm.

The feature field part generator 134 may segment the part feature field 132 into at least two parts 136. In some implementations, a user can determine a granularity of the feature field part generator 134. For example, the user can determine how many parts 136 the feature field part generator 134 segments the part feature field 132 into. As a result, the threshold of the clustering algorithm may change based on the user selection of granularity. The feature field part generator 134 can thus segment the part feature field 132 hierarchically based on the granularity and a desired number of the parts 136. The hierarchy can indicate which of the feature vectors to group together according to the granularity value. The granularity value can indicate, for example, a threshold for a difference between at least one of a similarity or distance between each of the feature vectors. The feature vectors that are at or below the threshold can be grouped (e.g., clustered) into one cluster, indicating a part 136. For example, the threshold may be lower for a desired number of parts 136 being 2 (e.g., lower granularity) and higher for a desired number of parts 136 being 8 (e.g., higher granularity).

As an example, responsive to the clustering algorithm being agglomerative clustering, each data point (e.g., point) on the part feature field 132 is treated as an individual cluster. The distance between each pair of clusters is then calculated. A computation of all the distances of each pair of clusters in the part feature field 132 may be represented by a distance matrix. The distance may be calculated by, for example, Euclidean or Manhattan distance. Based on the distance, the two clusters that are closest to each other are merged together to reduce a number of clusters of the part feature field 132. After merging the two clusters, the distance matrix can be updated to reflect distances between the merged cluster and remaining clusters. To compute the distances between these clusters, the feature field part generator 134 may use at least one of single linkage, complete linkage, average linkage, or Ward's method. Merging two clusters and updating the distance matrix is then repeated until either all data points on the part feature field 132 are in a single cluster, or until a threshold is met. The threshold can be a predefined number of clusters (e.g., predefined by the user). A hierarchical tree (e.g., dendrogram) can also be formed based on the clustering process. The hierarchical tree can be cut at a specified level to obtain a desired number of clusters.

The feature field generator 130 may thus output the parts 136 of the 3D volume based on the input geometry 104 of the 3D volume. In some implementations, the feature field generator 130 labels the parts 136. The parts 136 may retain fine-grained geometric details of the input geometry 104.

Following output of the parts 136, the parts 136 can be used to generate, for example, additional representations of the 3D volume (e.g., second representations). For example, the parts 136 can be input into a representation generator which can output representations of the 3D volume. The representations can include the 3D volume with adjustments (e.g., edits) to one or more parts of the 3D volume according to the parts. For example, one part can be enlarged. The representations can be at least one of a 3D or four-dimensional (4D) representation. The 4D representation can be a 3D representation with time as the additional dimension. For example, the 4D representation is a video or an animation of the 3D volume. The representation can be a representation of a singular part of the 3D volume. For example, responsive to the 3D volume being a chair, the representation can be a leg of the chair.

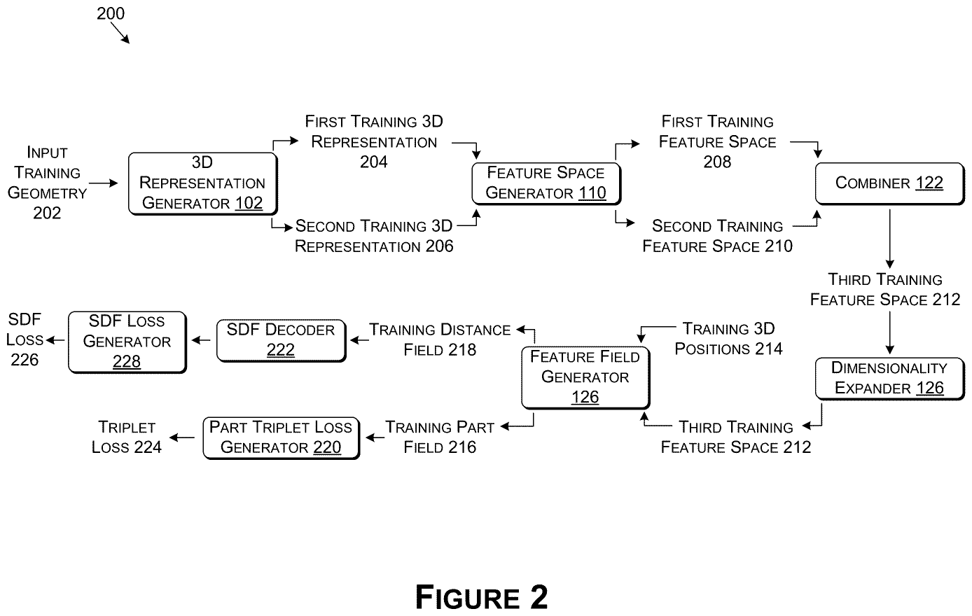

With reference to FIG. 2, FIG. 2 is an example system 200 for updating a system to segment a 3D volume, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 200 may include the 3D representation generator 102, the feature space generator 110, the combiner 122, the dimensionality expander 126, and the feature field generator 130 as described with respect to the system 100. The 3D representation generator 102 may receive an input training geometry 202 indicative of a training 3D volume. The training 3D volume may be included in a training dataset. The training dataset may include 3D labels and 2D labels of a plurality of training 3D volumes. The 3D labels may be derived from an annotated shape dataset without textures with information on internal structures of the training 3D volumes. The 2D labels may be derived from multi-view rendering of the training 3D volumes by a 2D segmentation model. Prior to updating (e.g., training), the feature field generator 130 may include a plurality of priors and a plurality of weights which may be randomly selected. The plurality of priors can include 3D data, data from 2D foundation models, and heuristics such as convexity, geometric primitives, or color, among others. The plurality of weights may be iteratively updated during the updating process until the feature field generator 130 reaches convergence.

To initialize and establish the feature field generator 130, the 3D representation generator 102 can receive the input training geometry 202 and generate at least one training 3D representation from the input training geometry 202. For example, the 3D representation generator 102 can generate a first training 3D representation 204 and a second training 3D representation 206 (e.g., similar to the first 3D representation 106 and the second 3D representation 108). The first training 3D representation 204. The first training 3D representation 204 can be an SDF volume while the second training 3D representation 206 is a point cloud. The feature space generator 110 can then receive the at least one training 3D representation to generate at least one feature space including a plurality of training feature vectors. For example, the feature space generator 110 generates the first training feature space 208 including a plurality of first training vectors and the second training feature space 210 including a plurality of second training vectors based on the first training 3D representation 204 and the second training 3D representation 206.

The combiner 122 can then receive the first training feature space 208 and the second training feature space 210 and combine the plurality of first training vectors and the plurality of second training vectors into a third training feature space 212. The third training feature space 212 can include a plurality of third training vectors. The dimensionality expander 126 can then apply the plurality of second neural networks to the third training feature space 212 to increase a dimension of the plurality of third training vectors. Following increase of the channel dimension of the third training feature space 212, the feature field generator 130 can receive the third training feature space 212 and the training 3D positions 214 (e.g., similar to the 3D positions 128). The training 3D positions 214 can be determined by at least one of the 3D representation generator 102 based on the input training geometry 202 or the feature space generator 110 responsive to the 3D representation generator 102 generating a point cloud.

The feature field generator 130 can project locations of a plurality of 3D points (e.g., the training 3D positions 214) of the training 3D volume to combine the plurality of training feature vectors of the third training feature space 212 with the training 3D positions 214. For example, the dimensionality expander 126, using the plurality of second neural networks, may transform the third training feature space 212 from 3D to 2D. The feature field generator 130 can then project the locations of the plurality of 3D points onto each pixel of the 2D image to generate a training part field 216 and a training distance field 218. The feature field generator 130 can split the combination of the training 3D positions 214 and the plurality of training feature vectors into a first portion and a second portion. For example, the first portion can have a dimension of 64 while the second portion has a dimension of 448. The first portion can be used to generate the training distance field 218 while the second portion is used to generate the training part field 216. The training distance field 218 may be an SDF feature field.

To update the plurality of weights of the feature field generator 130, the training part field 216 can be provided to a part triplet loss generator 220 and the training distance field 218 provided to an SDF decoder 222. The part triplet loss generator 220 can determine a first loss (e.g., triplet loss 224) which can be applied to the feature field generator 130 to update the plurality of weights. The training dataset can include a plurality of training triplet losses associated with each of the training 3D volumes. To determine the triplet loss 224, the part triplet loss generator 220 can sample triplets (e.g., a first point, a second point, and a third point) of the 3D volume (e.g., the input training geometry 202). Each point of each of the triplets can have a feature vector with a dimension of, for example, 448. For example, the part triplet loss generator 220 can sample 100,000 triplets. The triplets are then uniformly divided across parts of the training part field 216. For example, responsive to the training part field 216 providing 4 parts, each part is provided with 25,000 triplets.

Following uniform division of the triplets, the part triplet loss generator 220 labels the first point and the second point as positive which can be indicative of the first point and the second point belonging to a same part as indicated by the training dataset for each of the triplets. The part triplet loss generator 220 also labels the third point as negative which can be indicative of the third point belonging to a different part than the first point and the second point as indicated by the training dataset for each of the triplets. The part triplet loss generator 220 then determines the placement of the first point, the second point, and the third point as generated (e.g., placed) by the training part field 216. The part triplet loss generator 220 determines the triplet loss 224 by comparing the labels of the training dataset for each of the triplets to the placement of each point of the triplets by the training part field 216. The part triplet loss generator 220 can determine the triplet loss 224 by the equation (1):

$$triplet loss = - ( log ( \frac{exp ( cos AB ) / τ}{exp ( cos AB ) / τ + exp ( cos AC ) / τ} ) + log ( \frac{exp ( cos AB ) / τ}{exp ( cos AB ) / τ + exp ( cos BC ) / τ} ) ) / 2. \qquad ( 1 )$$

The equation (1) has one degree of freedom as indicated by the r which can be a differential parameter that is updated during the training (e.g., updating) process of the feature field generator 130. The equation (1) also enables the conversion of positive and negative triplets (e.g., positive and negative labels) into a continuous value penalty based on the distance between feature vectors (e.g., the first point, the second point, and the third point). The part triplet loss generator 220 can then apply the triplet loss 224 to the feature field generator 130 to update the plurality of weights (e.g., parameters) of the feature field generator 130 (e.g., at least one machine learning model) until the feature field generator 130 reaches convergence (e.g., the triplet loss 224 does not adjust the plurality of weights after inputting a series of the input training geometry 202).

To calculate an SDF loss 226, the training distance field 218 can first be input into the SDF decoder 222. The training dataset can also include training SDF information for each of the input training geometry 202. The SDF decoder 222 can decode the training distance field 218, and translate SDF information of the training distance field 218 to generate an SDF volume of the input training geometry 202 based on the distance information. Following decoding by the SDF decoder 222, an SDF loss generator 228 can generate the SDF loss 226 by first sampling (e.g., selecting) a plurality of points on the SDF volume. The SDF loss generator 228 can then compare a predicted SDF based on the plurality of points of the SDF volume to the training SDF information (e.g., SDF of a plurality of points in the training dataset, ground truth SDF). The SDF loss 226 can be calculated by equation (2):

$$SDF Loss = ‖ predicted\_sdf - ground\_truth \_sdf ‖ . \qquad ( 2 )$$

Based on the SDF loss 226, the SDF loss generator 228 can apply the SDF loss 226 to the feature field generator 130 to update the plurality of weights. The SDF loss 226 and the triplet loss 224 may be calculated in parallel or sequentially. For example, the triplet loss 224 may be calculated and applied to the feature field generator 130 prior to the SDF decoder 222 decoding the training distance field 218. The SDF loss generator 228 can calculate the SDF loss 226 and apply the SDF loss 226 to the feature field generator 130 until the feature field generator 130 reaches convergence.

In some implementations, training 3D volumes are added to the training dataset following the feature field generator 130 reaching convergence. In this case, the SDF loss generator 228 and the part triplet loss generator 220 generate the SDF loss 226 and the triplet loss 224, respectively, responsive to the feature field generator 130 generating the training part field 216 and the training distance field 218 for the added training 3D volumes. The SDF loss generator 228 and the part triplet loss generator 220 can then apply the SDF loss 226 and the triplet loss 224, respectively, to the feature field generator 130 to update the plurality of weights of the feature field generator 130.

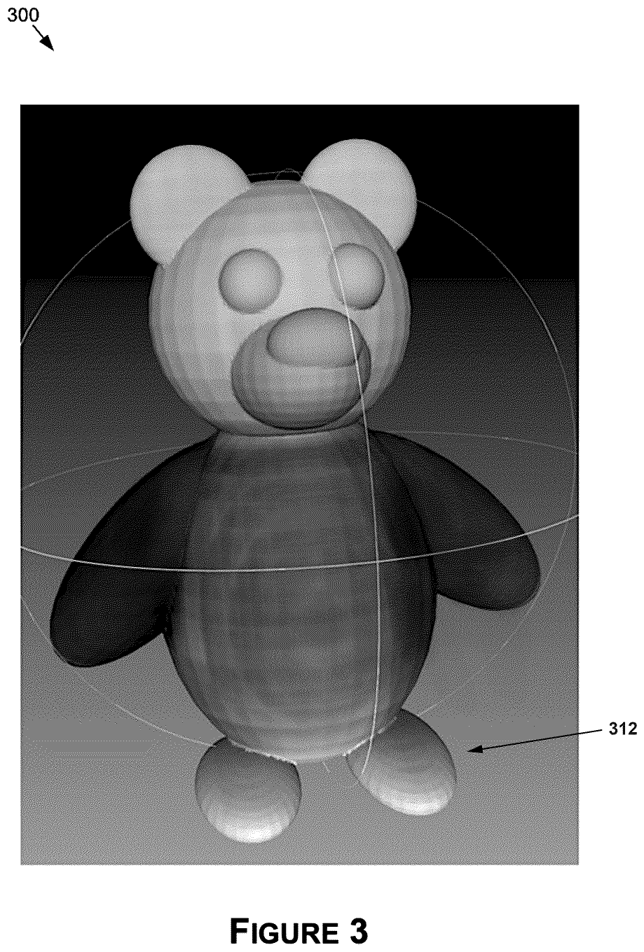

Now referring to FIG. 3, FIG. 3 depicts a part feature field 312 generated for a 3D volume 300. The part feature field 312 is an example of the part feature field 132. The part feature field 312 dictates how the 3D volume 300 is segmented by the feature field part generator 134. The part feature field 312 includes features at each point on the 3D volume 300. Different regions of the part feature field 312 (e.g., based on distance) may be denoted by different shading, as shown in FIG. 3.

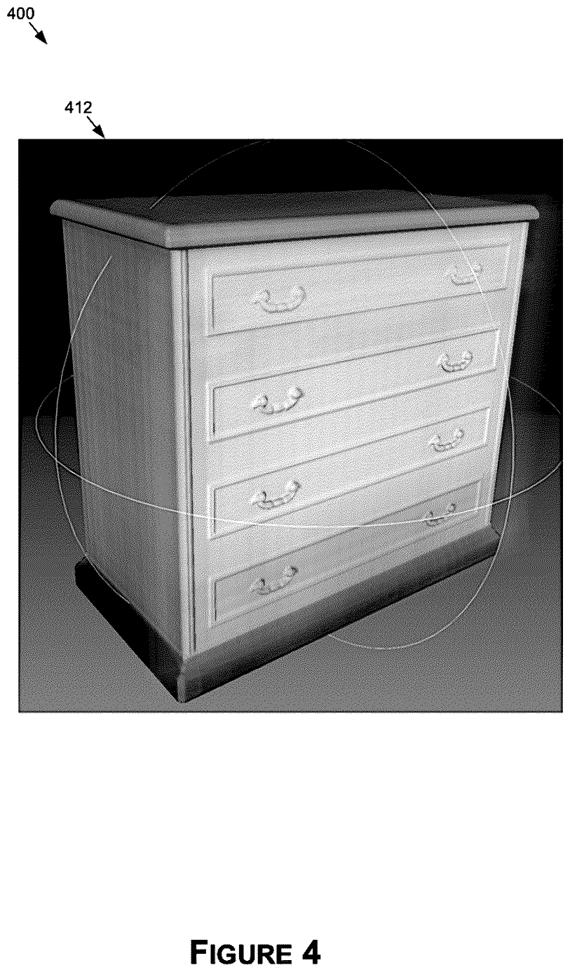

Now referring to FIG. 4, FIG. 4 depicts a part feature field 412 generated for a 3D volume 400. The part feature field 412 is an example of the part feature field 132. The part feature field 412 dictates how the 3D volume 400 is segmented by the feature field part generator 134. The part feature field 412 includes features at each point on the 3D volume 400. Different regions of the part feature field 412 (e.g., based on distance) may be denoted by different shading, as shown in FIG. 4.

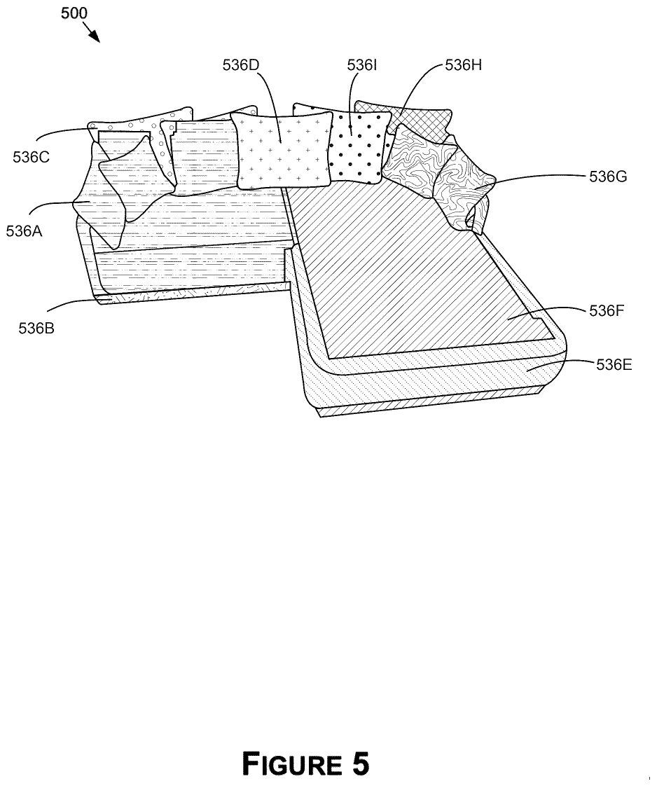

Now referring to FIG. 5, FIG. 5 depicts a segmented 3D volume 500 clustered by the feature field part generator 134 as determined by the part feature field 132. The segmented 3D volume 500 is a couch, and illustrates examples of the parts 136 of the segmented 3D volume 500. The examples of the parts 136 include, as shown in FIG. 5, the parts 536A-I (herein referred to as the parts 536). The parts 536 may be denoted (e.g., shown, depicted) with different shading as shown in FIG. 5. A number of the parts 536 of the segmented 3D volume 300 may increase or decrease dependent on the granularity of the feature field part generator 134. For example, as shown in FIG. 5, the segmented 3D volume 500 separates the couch by location of the feature vectors. The parts 536 can include at least pillows (e.g., the parts 536C, 536D, 536I, 536H, and a portion of 536G and 536A), cushions (e.g., a portion of 536A, 536E, and 536F), and a base of the couch (e.g., 536B and a portion of 536F). Separation of the parts 536 of the couch can be dependent on a distance between vectors of the part feature field 132 as well as the granularity of the feature field part generator 134. Segmentation of the segmented 3D volume 500 may not be restricted to semantic labels.

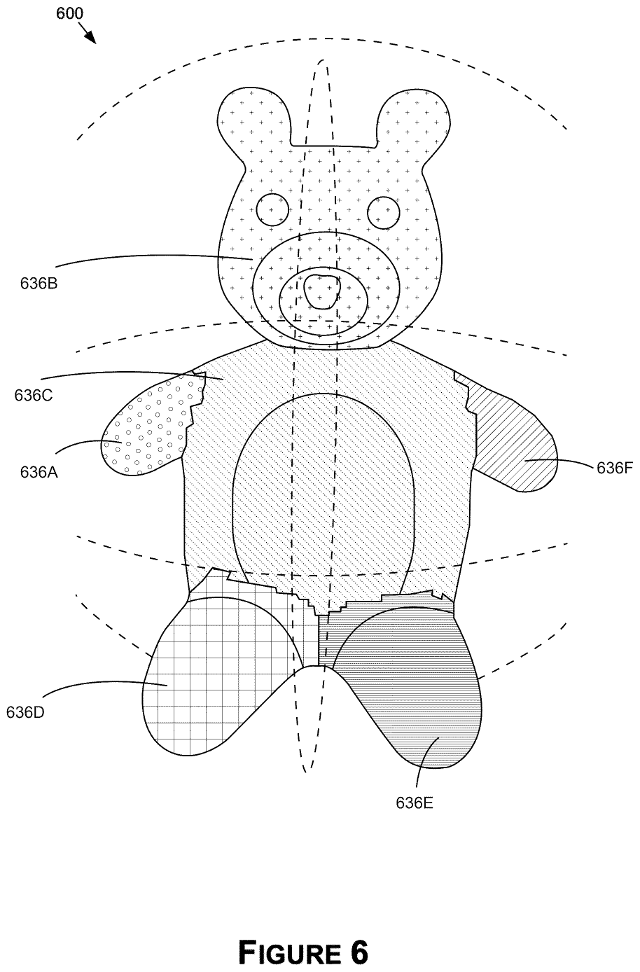

Now referred to FIG. 6, FIG. 6 depicts a segmented 3D volume 600 clustered by the feature field part generator 134 as determined by the part feature field 132. The segmented 3D volume 600 is a stuffed animal (e.g., teddy bear), and illustrates examples of the parts 136 of the segmented 3D volume 600. The examples of the parts 136 include, as shown in FIG. 3, the parts 636A-F (herein referred to as the parts 636). The parts 636 may be denoted (e.g., shown, depicted) with different shading as shown in FIG. 6. A number of the parts 636 of the segmented 3D volume 300 may increase or decrease dependent on the granularity of the feature field part generator 134. For example, as shown in FIG. 6, the segmented 3D volume 600 separates the stuffed animal by a location of the feature vectors. The parts 636 can include at least a head (e.g., part 636B), a first arm (e.g., part 636A), a second arm (e.g., part 636F), a torso (e.g., part 636C), a first leg (e.g., part 636D), and a second leg (e.g., part 636E). Segmentation of the segmented 3D volume 600 by the feature field part generator 134 can be determined by a distance between vectors of the part feature field 132 as generated by the feature field generator 130 as well as the granularity of the feature field part generator 134. Segmentation of the segmented 3D volume 600 may not be restricted to semantic labels.

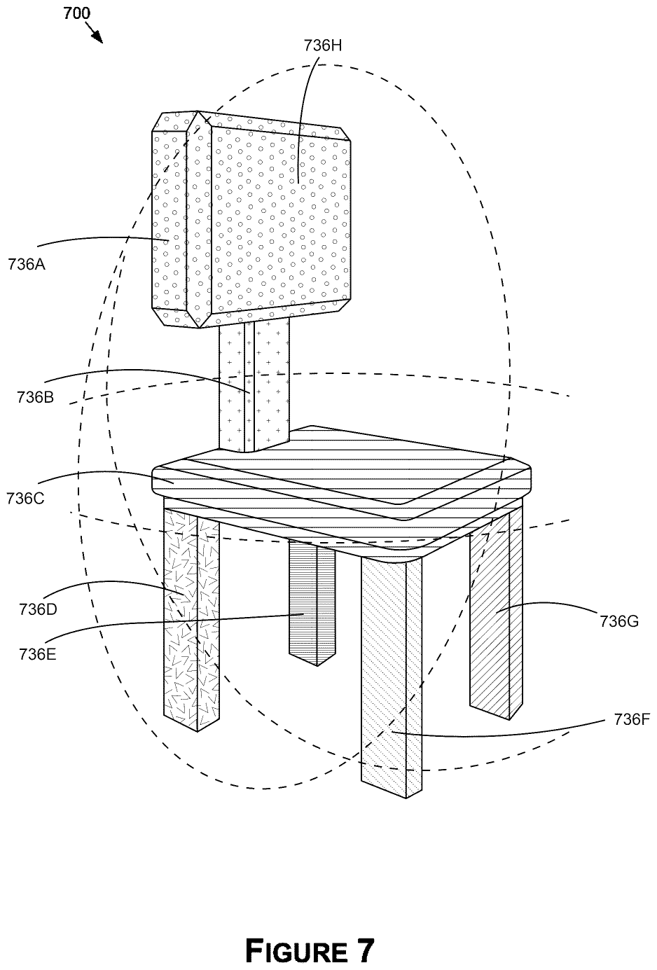

Now referring to FIG. 7, FIG. 7 depicts a segmented 3D volume 700 clustered by the feature field part generator 134 as determined by the part feature field 132. The segmented 3D volume 700 is a chair, and illustrates examples of the parts 136 of the segmented 3D volume 700. The examples of the parts 136 include, as shown in FIG. 7, the parts 736A-H (herein referred to as the parts 736). The parts 736 may be denoted (e.g., shown, depicted) with different shading as shown in FIG. 7. A number of the parts 736 of the segmented 3D volume 300 may increase or decrease dependent on the granularity of the feature field part generator 134. For example, as shown in FIG. 7, the segmented 3D volume 700 separates the chair by location of the feature vectors. The parts 736 can include chair legs (e.g., parts 736D-G), a chair seat (e.g., part 736C), a chair back (e.g., parts 736A-B and H). Separation of the parts 736 of the chair can be dependent on a distance between vectors of the part feature field 132 as well as the granularity of the feature field part generator 134. Segmentation of the segmented 3D volume 700 may not be restricted to semantic labels.

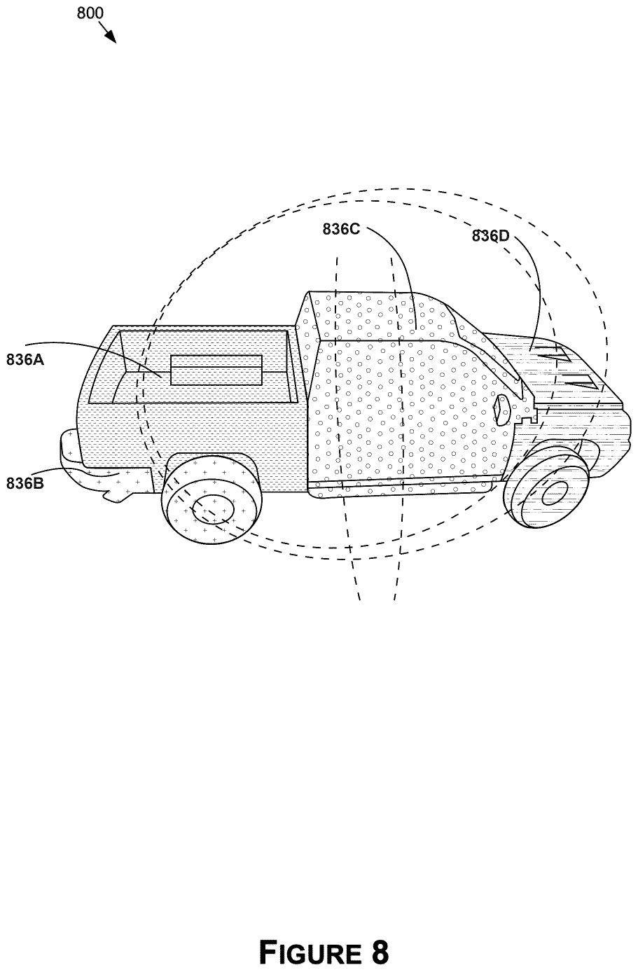

Now referring to FIG. 8, FIG. 8 depicts a segmented 3D volume 800 clustered by the feature field part generator 134 as determined by the part feature field 132. The segmented 3D volume 800 is a car, and illustrates examples of the parts 136 of the segmented 3D volume 800. The examples of the parts 136 include, as shown in FIG. 8, the parts 836A-D (herein referred to as the parts 836). The parts 836 may be denoted (e.g., shown, depicted) with different shading as shown in FIG. 8. A number of the parts 836 of the segmented 3D volume 300 may increase or decrease dependent on the granularity of the feature field part generator 134. For example, as shown in FIG. 8, the segmented 3D volume 800 separates the car by location of the feature vectors. The parts 836 can include a car trunk (e.g., part 836A), a back wheel portion (e.g., part 836B), a middle portion (e.g., part 836C), and a front portion (e.g., part 836D). The granularity of the feature field part generator 134 for generating the segmented 3D volume 800 may be lower than the granularity for generating the segmented 3D volume 700. Separation of the parts 836 of the car can be dependent on a distance between vectors of the part feature field 132 as well as the granularity of the feature field part generator 134. Segmentation of the segmented 3D volume 800 may not be restricted to semantic labels.

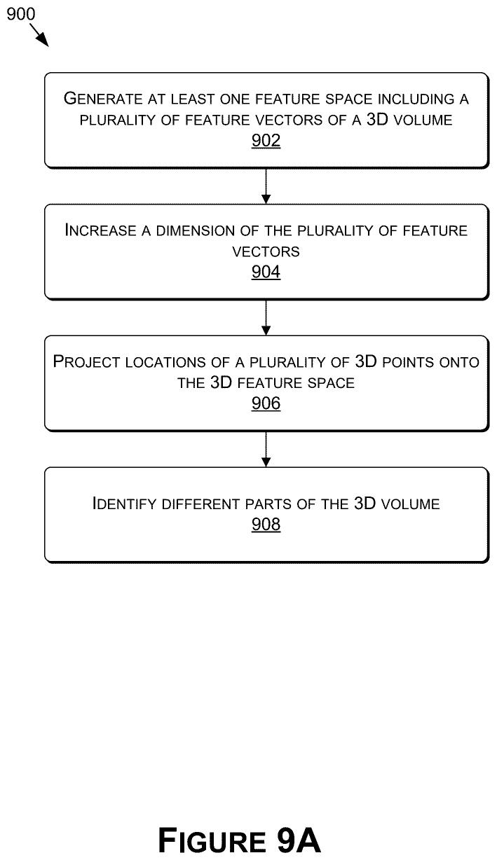

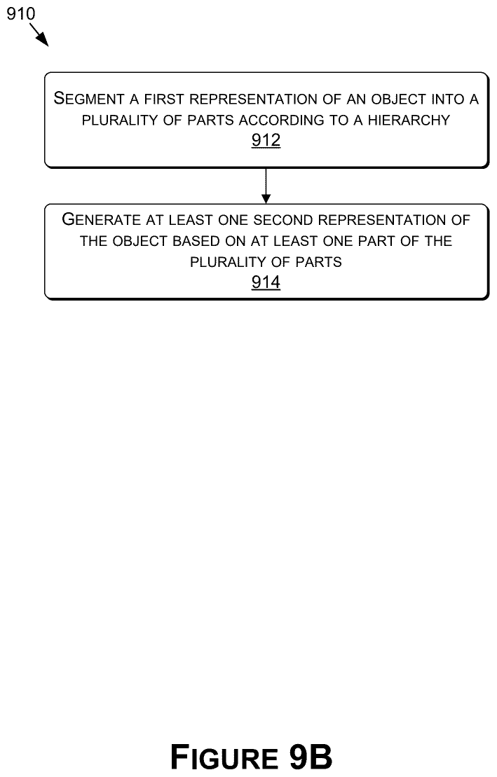

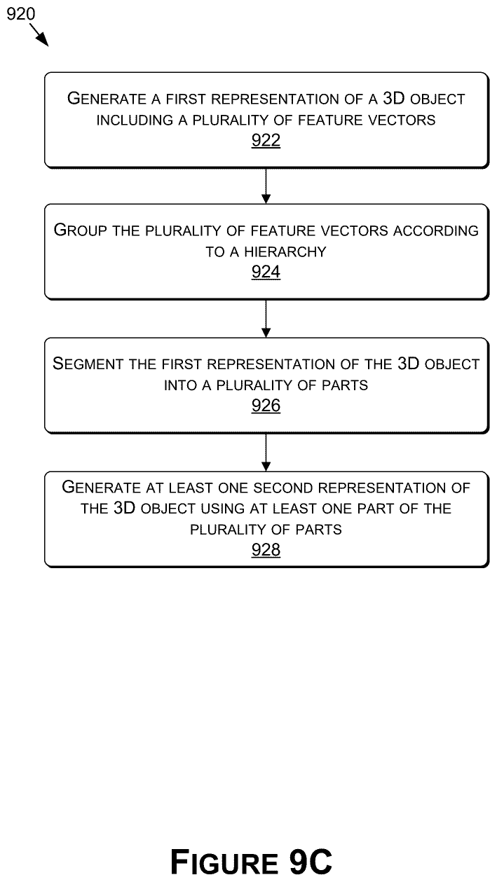

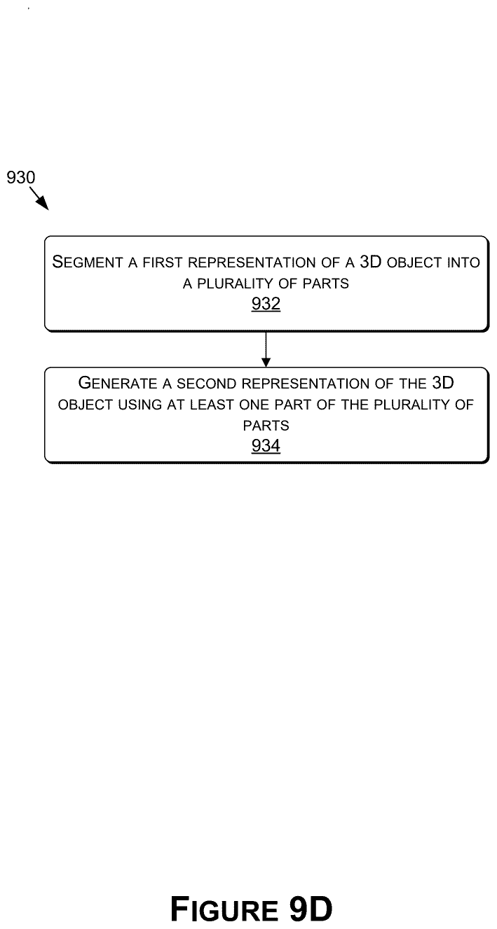

FIGS. 9A-D are flow diagrams showing methods for segmenting a 3D volume and generating representations based on the segmentation of the 3D volume. Now referring to FIG. 9A, each block of method 900, described herein, comprises a computing process that may be performed using any combination of hardware, firmware, and/or software. For instance, various functions may be carried out by a processor executing instructions stored in memory. The method 900 may also be embodied as computer-usable instructions stored on computer storage media. The method 900 may be provided by a standalone application, a service or hosted service (standalone or in combination with another hosted service), or a plug-in to another product, to name a few. In addition, method 900 is described, by way of example, with respect to the system of FIG. 1. However, this method 900 may additionally or alternatively be executed by any one system, or any combination of systems, including, but not limited to, those described herein.

FIG. 9A is a flow diagram showing a method 900 for segmenting a 3D volume, in accordance with some implementations of the present disclosure. The method 900, at block 902, includes generating at least one feature space including a plurality of feature vectors of a 3D volume. The feature space can be generated based on a 3D representation determined from an input 3D geometry of the 3D volume. The feature space can be a triplane. In some implementations, the method 900 includes determining a plurality of features of the 3D volume. The plurality of features can be determined by at least one of determining surface features of the 3D volume including at least one of color or texture or rendering the 3D volume into a 2D image and inputting the 2D image into a plurality of self-supervised learning models to encode the 2D image and generate features of the 3D volume. The plurality of features can then be combined with the plurality of feature vectors of the feature space.

In some implementations, the feature space is generated by a plurality of first neural networks. The plurality of first neural networks can include at least one of a 3D convolutional U-net, a point-voxel convolutional neural network (PVCNN), a sparse convolutional model, a 3D convolutional neural network, and point cloud models.

At block 904, the method 900 includes increasing a dimension of the plurality of feature vectors by a plurality of second neural networks. As a result, a channel dimension of the feature space is increased. The plurality of second neural networks can include at least one convolutional block (e.g., 2D convoluter) and at least one 2D transformer.

At block 906, the method 900 includes projecting locations of a plurality of 3D points of the 3D volume onto the feature space to combine the plurality of feature vectors and the plurality of 3D points. The plurality of 3D points can be derived from, for example, the input geometry of the 3D volume.

At block 908, the method 900 includes identifying, by at least one machine learning model, different parts of the 3D volume based at least in part on a part feature field generated at least in part by the combination of the plurality of feature vectors and the plurality of 3D points. In some implementations, to identify the different parts of the 3D volume, the part feature field includes a plurality of part feature vectors segmented by a clustering algorithm based at least in part on a distance between the plurality of part feature vectors.

Now referring to FIG. 9B, each block of method 910, described herein, comprises a computing process that may be performed using any combination of hardware, firmware, and/or software. For instance, various functions may be carried out by a processor executing instructions stored in memory. The method 910 may also be embodied as computer-usable instructions stored on computer storage media. The method 910 may be provided by a standalone application, a service or hosted service (standalone or in combination with another hosted service), or a plug-in to another product, to name a few. In addition, method 910 is described, by way of example, with respect to the system of FIG. 1. However, this method 910 may additionally or alternatively be executed by any one system, or any combination of systems, including, but not limited to, those described herein.

FIG. 9B is a flow diagram showing a method 910 for segmenting an object (e.g., 3D volume 300) into a plurality of parts (e.g., parts 136) and generating a representation of the object based on at least one part of the plurality of parts, in accordance with some implementations of the present disclosure. At block 912, the method 910 include segmenting a first representation of an object into a plurality of parts according to a hierarchy (e.g., hierarchical K-means clustering). The hierarchy can indicate groups of datapoints (e.g., points) for at least one part of the plurality of parts based on a value. The value can be a granularity value and can indicate a number of parts for which to segment the first representation of the object into. The hierarchy can indicate at least one of a similarity or a distance between datapoints. The at least one machine learning model can cluster the datapoints based on the value using the at least one of the similarity or the distance between at least two of the datapoints. To segment the first representation of the object into the plurality of parts, the method 910 can include generating a feature space (e.g., first feature space 112) including a plurality of feature vectors of the first representation of the object. The first representation of the object can be segmented based one at least one of a similarity or a distance between at least two of the plurality of feature vectors. The groups of data points can be clusters.

In various implementations, the at least one machine learning model includes at least one of: a 3D convolutional U-net, a point-voxel convolutional neural network (PVCNN), a sparse convolutional model, a 3D convolutional neural network, a point cloud model, at least one two-dimensional (2D) convoluter, at least one transformer, or a clustering algorithm.

At block 914, the method 910 includes generating at least one second representation of the object based on at least one part of the plurality of parts. The first representation of the object and the at least one second representation of the object can be 3D. In various implementations, the method 910 can include adjusting the at least one second representation according to the at least one part of the plurality of parts. For example, the at least one second representation can be edited following generation using the at least one of the plurality of parts. The method 910 can include generating the first representation of the object prior to segmenting the first representation of the object into the plurality of parts using the at least one machine learning model. For example, the first representation of the object can be a machine learning generated first representation of the object. The at least one second representation of the object can include at least one second representation of one of the plurality of parts. The at least one second representation of the object can include at least one of a 3D or 4D representation.

Now referring to FIG. 9C, each block of method 920, described herein, comprises a computing process that may be performed using any combination of hardware, firmware, and/or software. For instance, various functions may be carried out by a processor executing instructions stored in memory. The method 920 may also be embodied as computer-usable instructions stored on computer storage media. The method 920 may be provided by a standalone application, a service or hosted service (standalone or in combination with another hosted service), or a plug-in to another product, to name a few. In addition, method 920 is described, by way of example, with respect to the system of FIG. 1. However, this method 920 may additionally or alternatively be executed by any one system, or any combination of systems, including, but not limited to, those described herein.

FIG. 9C is a flow diagram of a method 920 for segmenting a representation of a 3D object (e.g., first 3D representation 106) into a plurality of parts (e.g., parts 136) and generating representations of the 3D object using at least one of the plurality of parts. At block 922, the method 920 includes generating a first representation of a 3D object including a plurality of feature vectors. The plurality of feature vectors can correspond to each point of the 3D object. The first representation of the 3D object can be a feature space of the 3D object and can be a triplane.

At block 924, the method 920 includes grouping the plurality of feature vectors according to a hierarchy. The plurality of features vectors can be grouped using a second machine learning model based at least in part on a similarity between at least two of the plurality of feature vectors. The hierarchy can be based on at least one of the similarity of the at least two of the plurality of feature vectors and a distance between the at least two of the plurality of feature vectors. The plurality of feature vectors can be grouped according to a granularity value of the hierarchy indicative of a threshold for which to cluster the plurality of feature vectors. The second machine learning model can be a clustering algorithm and the plurality of feature vectors are clustered.

At block 926, the method 920 includes segmenting the first representation into a plurality of parts based on the groups of feature vectors. The first representation can be segmented according to, for example, the granularity value. For example, responsive to the granularity value being 2, the first representation is segmented into 2 parts.

At block 928, the method 920 includes generating at least one second representation of the 3D object using at least one of the plurality of parts. The at least one second representation of the 3D object can include at least one of a 3D or 4D representation. For example, the second representation can be a 4D representation and the first representation can be a 3D representation. The plurality of parts can be moved (e.g., adjusted, edited, shaped) to generate the 4D representation.

Now referring to FIG. 9D, each block of method 930, described herein, comprises a computing process that may be performed using any combination of hardware, firmware, and/or software. For instance, various functions may be carried out by a processor executing instructions stored in memory. The method 930 may also be embodied as computer-usable instructions stored on computer storage media. The method 930 may be provided by a standalone application, a service or hosted service (standalone or in combination with another hosted service), or a plug-in to another product, to name a few. In addition, method 930 is described, by way of example, with respect to the system of FIG. 1. However, this method 930 may additionally or alternatively be executed by any one system, or any combination of systems, including, but not limited to, those described herein.

FIG. 9D is a flow diagram of a method 930 for segmenting a representation of a 3D object (e.g., first 3D representation 106) into a plurality of parts (e.g., parts 136) and generating representations of the 3D object using the plurality of parts. At block 932, the method 930 includes segmenting a first representation of a 3D object into a plurality of parts. The first representation can be segmented using at least one algorithm according to a hierarchy. The 3D object can include a plurality of datapoints. The hierarchy can be indicative of at least one of a similarity or difference between at least two of the plurality of datapoints. The first representation of the 3D object can be segmented according to a value. The value can be indicative of a number of parts to segment the first representation of the 3D object into. The at least one algorithm can be a clustering algorithm. The plurality of datapoints can be clustered according to the hierarchy.

At block 934, the method 930 includes generating a second representation of the 3D object using at least one of the plurality of parts. The second representation can be different than the first representation, and can be used for various applications, such as gaming, simulations, or animation. For example, the second representation can be one part of the 3D object, and the one part can be edited to move in a specific direction.

### Example Computing Device

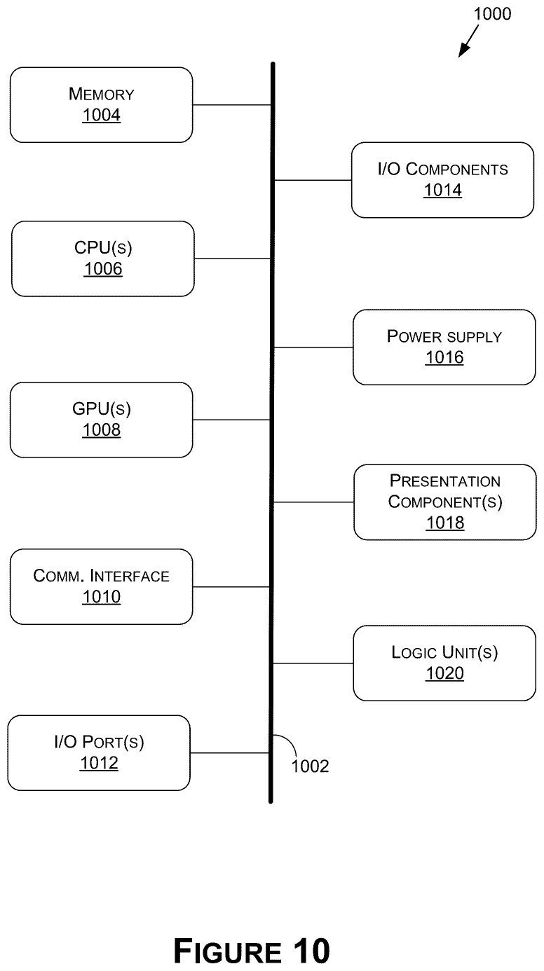

FIG. 10 is a block diagram of an example computing device(s) 1000 suitable for use in implementing some implementations of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some implementations, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In implementations, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In implementations, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In implementations, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. For example, the I/O components 1014 may allow a user to adjust a granularity of the feature field generator 130. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.). For example, at least one of the segmented 3D volume 300 or the segmented 3D volume 400 can be displayed on at least the presentation component(s) 1018.

### Example Data Center

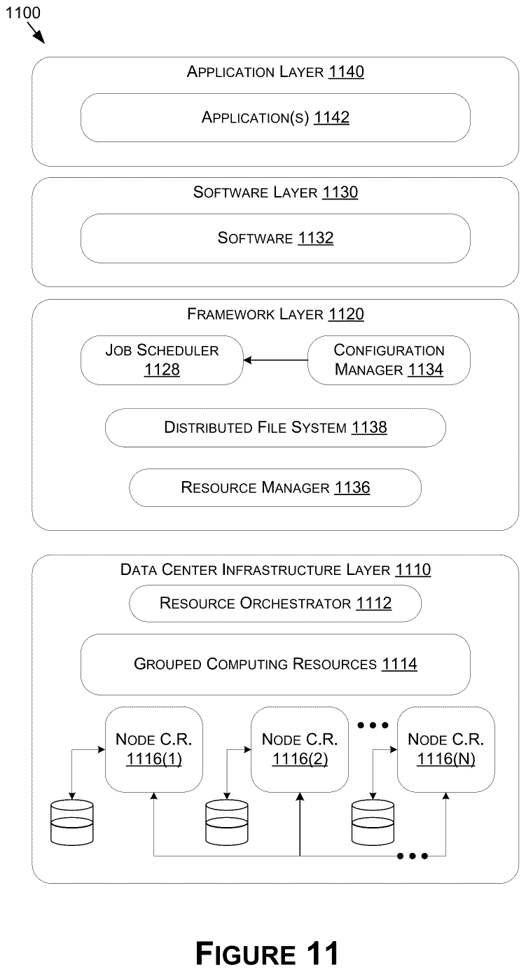

FIG. 11 illustrates an example data center 1100 that may be used in at least one implementations of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 1116(1)-1116(N) may correspond to a server having one or more of the above-mentioned computing resources. In addition, in some implementations, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. For example, the software layer 1130 may include the system 100. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 600. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system, comprising one or more processors to:
segment, using at least one machine learning model, a first representation of an object into a plurality of parts according to a hierarchy, wherein the hierarchy indicates groups of datapoints for at least one part of the plurality of parts based on a value; and
generate at least one second representation of the object based on the at least one part of the plurality of parts.

2. The system of claim 1, wherein the value is a granularity value and indicates a number of parts for which to segment the first representation of the object into.

3. The system of claim 1, wherein at least one of the first representation of the object or the at least one second representation of the object is a three dimensional (3D) representation.

4. The system of claim 1, wherein the hierarchy indicates at least one of a similarity or a distance between datapoints, and the at least one machine learning model clusters the datapoints based on the value using the at least one of the similarity or the distance between the datapoints.

5. The system of claim 2, wherein to segment the first representation of the object into the plurality of parts, the one or more processors are to generate a feature space comprising a plurality of feature vectors of the first representation of the object, the first representation of the object being segmented based at least partially on a similarity and a distance between at least two feature vectors of the plurality of feature vectors.

6. The system of claim 1, wherein the one or more processors adjust the at least one second representation of the object according to at least one of the plurality of parts.

7. The system of claim 1, wherein the one or more processors generate, using the at least one machine learning model, the first representation of the object prior to segmenting the first representation of the object into the plurality of parts.

8. The system of claim 1, wherein the at least one second representation of the object comprises at least one representation of one of the plurality of parts.

9. The system of claim 1, wherein the at least one second representation of the object comprise at least one of a 3D or four-dimensional (4D) representation.

10. The system of claim 1, wherein the groups of datapoints are clusters.

11. The system of claim 1, wherein the at least one machine learning model comprises at least one of: a 3D convolutional U-net, a point-voxel convolutional neural network (PVCNN), a sparse convolutional model, a 3D convolutional neural network, a point cloud model, at least one two-dimensional (2D) convoluter, at least one transformer, or a clustering algorithm.

12. The system of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing vision language models (VLMs);
a system implementing large language models (LLMs);
a system implementing multi-modal language models;
a system for hosting one or more real-time streaming applications;
a system for performing light transport simulation;
a system using or deploying one or more inference microservices;
a system that incorporates one or more machine learning models deployed in a service or microservice along with an OS-level virtualization package (e.g., a container);
a system for performing collaborative content creation for 3D assets; or
a system implemented at least partially using cloud computing resources.

13. A system, comprising one or more processors to:
generate, using a first machine learning model, a first representation of a three dimensional (3D) object comprising a plurality of feature vectors corresponding to each point of the 3D object;
group, using a second machine learning model, the plurality of feature vectors according to a hierarchy based at least in part on a similarity of the plurality of feature vectors;
segment the first representation of the 3D object into a plurality of parts based on the groups of feature vectors; and
generate at least one second representation of the 3D object using at least one of the plurality of parts.

14. The system of claim 13, wherein the hierarchy is based on at least one of the similarity of the feature vectors or a distance between at least two of the plurality of feature vectors.

15. The system of claim 13, wherein the plurality of feature vectors are grouped according to a granularity value of the hierarchy indicative of a threshold for which to cluster the plurality of feature vectors.

16. The system of claim 13, wherein the second machine learning model is a clustering algorithm and the plurality of feature vectors are clustered.

17. The system of claim 13, wherein the at least one second representation of the 3D object comprise at least one of a 3D or four-dimensional (4D) representation.

18. A system, comprising one or more processors to:
segment, using at least one algorithm, a first representation of a three dimensional (3D) object comprising a plurality of datapoints into a plurality of parts according to a hierarchy, the hierarchy indicative of at least one of a similarity or a distance between each of the plurality of datapoints; and
generate a second representation of the 3D object using at least one of the plurality of parts.

19. The system of claim 18, wherein the first representation of the 3D object is segmented according to a value indicative of a number of parts to segment the first representation of the 3D object into.

20. The system of claim 18, wherein the at least one algorithm is a clustering algorithm, and the plurality of datapoints is clustered according to the hierarchy.
